(19) United States
(12) Patent Application Publication
(10) Pub. No.: US 2020/0311059 A1
(43) Pub. Date: Oct. 1, 2020

(54) MULTI-LAYER WORD SEARCH OPTION

(71) Applicant: Konica Minolta Laboratory U.S.A., Inc., San Mateo, CA (US)

(72) Inventor: Takayuki Kamata, Superior, CO (US)

(73) Assignee: Konica Minolta Laboratory U.S.A., Inc., San Mateo, CA (US)

(21) Appl. No.: 16/369,293

(22) Filed: Mar. 29, 2019

(51) Int. Cl. G06F 16/248; G06K 9/46; G06F 17/27; G06F 16/93

(52) U.S. Cl. CPC G06F 16/248; G06K 9/46; G06K 2209/01; G06F 16/93; G06F 17/2785

(57) ABSTRACT

A method for a computer processor to generate a searchable electronic document (ED). The method includes generating, from an electronic image and based on a character recognition (CR) algorithm, a plurality of characters and a confidence level of the plurality of characters forming a word, generating, based on the CR algorithm and in response to the confidence level being less than a predetermined threshold, a plurality of character combinations for the word, generating, based on a predetermined criterion, a confidence level of each of the plurality of character combinations, and generating the searchable ED by including, based on the confidence level of each of the plurality of character combinations, two or more character combinations of the plurality of character combinations in two or more layers of the searchable ED.

### BACKGROUND

Optical character recognition (OCR) is electronic conversion of images of typed, handwritten or printed text into machine-encoded text, whether from a scanned document, a photo of a document, or other images that include or superimposed with text. Intelligent character recognition (ICR) is an advanced form of OCR that is used in handwriting recognition. Generally, OCR/ICR results are not perfect and may include errors such as incorrect spelling of a word or unintended conversion from one word to a different word. In a searchable ED containing OCR/ICR errors, a user may not find search result containing the correct word.

Electronic documents (EDs) are used by computing device users to store, share, archive, and search information. EDs are stored, temporarily or permanently, in files. Many different file formats exist, such as Portable Document Format (PDF). Each file format defines how the content of the file is encoded.

Layers, or more formally known as Optional Content Groups (OCGs), refer to sections of content in a PDF document that can be selectively viewed or hidden by document authors or users. This capability consists of an Optional Content Properties Dictionary added to the document root. This dictionary contains an array of Optional Content Groups (OCGs), each describing a set of information that may be individually displayed or suppressed, plus a set of Optional Content Configuration Dictionaries, which give the status (Displayed or Suppressed) of the given OCGs.

### SUMMARY

In general, in one aspect, the invention relates to a method for a computer processor to generate a searchable electronic document (ED). The method includes generating, from an electronic image and based on a character recognition (CR) algorithm, a plurality of characters and a confidence level of the plurality of characters forming a word, generating, based on the CR algorithm and in response to the confidence level being less than a predetermined threshold, a plurality of character combinations for the word, generating, based on a predetermined criterion, a confidence level of each of the plurality of character combinations, and generating the searchable ED by including, based on the confidence level of each of the plurality of character combinations, two or more character combinations of the plurality of character combinations in two or more layers of the searchable ED.

In general, in one aspect, the invention relates to a non-transitory computer readable medium (CRM) storing computer readable program code for generating a searchable electronic document (ED). The computer readable program code, when executed by a computer processor, comprises functionality for generating, from an electronic image and based on a character recognition (CR) algorithm, a plurality of characters and a confidence level of the plurality of characters forming a word, generating, on the CR algorithm and in response to the confidence level being less than a predetermined threshold, a plurality of character combinations for the word, generating, based on a predetermined criterion, a confidence level of each of the plurality of character combinations, and generating the searchable ED by including, based on the confidence level of each of the plurality of character combinations, two or more character combinations of the plurality of character combinations in two or more layers of the searchable ED.

In general, in one aspect, the invention relates to a system for generating a searchable electronic document (ED). The system includes a memory, and a computer processor connected to the memory and that generates, from an electronic image and based on a character recognition (CR) algorithm, a plurality of characters and a confidence level of the plurality of characters forming a word, generates, on the CR algorithm and in response to the confidence level being less than a predetermined threshold, a plurality of character combinations for the word, generates, based on a predetermined criterion, a confidence level of each of the plurality of character combinations, and generates the searchable ED by including, based on the confidence level of each of the plurality of character combinations, two or more character combinations of the plurality of character combinations in two or more layers of the searchable ED.

Other aspects of the invention will be apparent from the following description and the appended claims.

### BRIEF DESCRIPTION OF DRAWINGS

FIG. 1 shows a system in accordance with one or more embodiments of the invention.

FIGS. 2A-2B shows a flowchart in accordance with one or more embodiments of the invention.

FIGS. 3A-3B show an implementation example in accordance with one or more embodiments of the invention.

FIG. 4 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method, non-transitory computer readable medium, and system to increase the possibility to search a word through standard text searching tools in an operating system or software application. The improved search capability is based on including character recognition results in multiple layers of a searchable electronic document (ED). In one or more embodiments of the invention, character sequences corresponding to words are generated from an electronic image based on a character recognition (CR) algorithm. In response to the CR confidence level of a character sequence being less than a predetermined threshold, a number of character combinations for the corresponding word are generated. The searchable ED is generated by including, based on the confidence level of each character combination, multiple character combinations in multiple layers of the searchable ED. Accordingly, the text searching tool searches each layer of the searchable ED to match the word to each of the multiple character combinations.

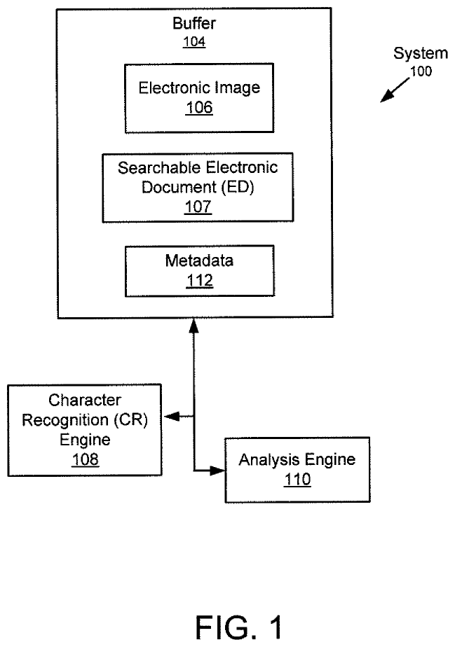

FIG. 1 shows a system (100) in accordance with one or more embodiments of the invention. As shown in FIG. 1, the system (100) has multiple components, including, for example, a buffer (104), a character recognition (CR) engine (108), and an analysis engine (110). Each of these components (104, 108, 110) may be located on the same computing device (e.g., personal computer (PC), laptop, tablet PC, smart phone, multifunction printer, kiosk, server, etc.) or on different computing devices connected by a network of any size having wired and/or wireless segments. Each of these components is discussed below.

In one or more embodiments of the invention, the buffer (104) may be implemented in hardware (i.e., circuitry), software, or any combination thereof. The buffer (104) is configured to store an electronic image (106). At least a portion of the electronic image (106) includes text images made up of character images. The text images and character images include character/text information based on a creator's intent. The creator of the character/text information is the author of the corresponding typed, printed, or handwritten text. Throughout this disclosure, the terms “creator” and “author” may be used interchangeably depending on the context. The electronic image (106) may also be a portion of an electronic document that further includes machine-encoded text and/or graphics content, such as a PDF document. The electronic image (106), or the electronic document containing the electronic image (106), may be obtained (e.g., downloaded, scanned, etc.) from any source. For example, the electronic image (106) may be a scanned document, a photo of a document, or other images of a scene that includes or is superimposed with typed, printed, or handwritten text. The electronic image (106) may be a part of a collection of electronic images. Further, the electronic image (106) may be of any size and in any format (e.g., PDF, JPEG, PNG, TIFF, etc.).

In one or more embodiments of the invention, the CR engine (108) may be implemented in hardware (i.e., circuitry), software, or any combination thereof. The CR engine (108) performs a character recognition algorithm (CR algorithm) to parse the electronic image (106) to extract and convert text images in the electronic image (106) into recognized words. For example, the text image may be a pixel-based bit map image that includes character/text information based on a creator's intent. As used herein, a recognized word is a combination of characters generated by applying the CR algorithm to analyze a text image. The recognized word is delimited by blank spaces in the text image.

In one or more embodiments, the CR engine (108) extracts and converts character images in a text image into individual characters (referred to as recognized characters) that form a character combination. In other words, the character combination is a combination of recognized characters generated by the CR engine (108). From time to time, for the same text image, the recognized word may not match a corresponding character combination. For example, due to character recognition ambiguity, the recognized word may include a letter “o” that corresponds to a numeral “0” in the character combination. In another example, due to character recognition ambiguity, the recognized word may include a lower case letter “1” that corresponds to a numeral “1” or an upper case letter “I” in the character combination. When the character recognition ambiguity occurs for multiple characters in the recognized word, multiple character combinations exist for the single recognized word based on logical combinations of different CR results for each of the individual characters. Whether matched to each other or not, the recognized word and associated character combinations are said to correspond to the text image from which the CR engine (108) generates the recognized word. In other words, the recognized word, the character combinations, and the text image are said to be corresponding to one another. In such context, each text image in the electronic image is also referred to as the corresponding word in the electronic image. Specifically, the term “corresponding word” means the pixel-based bit map image depicting the word instead of the machine-encoded value representing the word. In one or more embodiments, the CR engine (108) outputs individual recognized characters only, in which case the character combination may be formed by the analysis engine (110) described below. In one or more embodiments, the CR engine (108) outputs the character combination for use by the analysis engine (110). For example, the CR engine (108) may selectively output the character combination in response to a request from the analysis engine (110).

The confidence level of a recognized word is a measure of confidence that the recognized word correctly represents the corresponding text image in the electronic image (106) as intended by the creator of the text information in the electronic image (106). The confidence level of a recognized character is a measure of confidence that the recognized character correctly represents the corresponding character image in the electronic image (106) as intended by the creator of the character information in the electronic image (106). The confidence level of a character combination is a measure of confidence that the individually recognized characters correctly represent the corresponding text image in the electronic image (106) as intended by the creator of the character information in the electronic image (106). For example, the confidence level may be represented as a percentage (e.g., 0-100%), a number (e.g., a scale from 0 to 10, or from 0 to 100, etc.), a fraction (e.g., from 0 to 1), etc. The confidence levels of the recognized word, the recognized character, and/or the character combination may be reduced due to character recognition ambiguity described above.

In one or more embodiments of the invention, the CR engine (108) generates the confidence level of each recognized word and the confidence level of each recognized character based on intermediate results of the CR algorithm. For example, the intermediate results may include computed correlation between a text image and predetermined word/character templates used by the CR algorithm. Accordingly, the confidence level of each character combination is generated, by the CR engine (108) or the analysis engine (110) described below, using a pre-determined formula based on the confidence levels of individual characters. In contrast to the confidence levels of the recognized words and recognized characters, the confidence level of the character combination is not directly generated from the same intermediate results of CR algorithm. The confidence levels of the recognized word, the recognized character, and/or the character combination are generated by the CR engine (108) as default or generated by the CR engine (108) selectively. In one or more embodiments, the CR engine (108) selectively generates the confidence levels of the recognized word, the recognized character, and/or the character combination in response to a request from the analysis engine (110).

In one or more embodiments of the invention, the analysis engine (110) may be implemented in hardware (i.e., circuitry), software, or any combination thereof. In particular, the analysis engine (110) is configured to generate a searchable electronic document (ED) (107) based on results of the CR engine (108). In one or more embodiments, the searchable ED (107) includes multiple layers. For example, a visible layer of the searchable ED (107) may be a representation of the electronic image (106), while one or more invisible layer(s) of the searchable ED (107) may include recognized words and/or character combinations generated by the CR engine (108). For example, the visible layer may be outputted as a display of the electronic image (106) for user viewing. In contrast, the invisible layer may be accessed by a text searching tool to match a search phrase to one or more recognized words and/or character combinations. For example, the invisible layers of the searchable ED (107) may include the recognized words and/or character combinations, and references to corresponding locations in the visible layer representation of the electronic image (106). In one or more embodiments, the searchable ED (107) is a PDF document and the layers are OCGs of the PDF document. In one or more embodiments, the searchable ED (107) is a format different from PDF document and the layers are data structures corresponding to OCGs of the PDF document. The searchable ED (107) may be stored in the buffer (104).

In one or more embodiments of the invention, the analysis engine (110) generates metadata (112) of the searchable ED (107) that corresponds to intermediate and/or final results of the analysis engine (110), such as confidence levels of character combinations, association between character combinations and layers of the searchable ED (107), etc. In other words, the metadata (112) includes information that represents intermediate and/or final results of the analysis engine (110). As noted above, the confidence level of a character combination is a measure of confidence that the character combination correctly represents the corresponding text image in the electronic image (106) as intended by the creator of the character information in the electronic image (106). In one or more embodiments, the analysis engine (110) generates the confidence level of the character combination by aggregating the confidence levels of individual recognized characters of the character combination, which are initially generated by the CR engine (108). In one or more embodiments, the analysis engine (110) obtains the confidence level of the character combination from the CR engine (108). The association between recognized words and layers of the searchable ED (107) includes references (e.g., layer ID) to invisible layers containing the recognized words and references to corresponding locations in the visible layer representation of the electronic image (106). In one or more embodiments, the analysis engine (110) stores the metadata (112) in the buffer (104). The metadata (112) may be stored in the invisible layer in association with corresponding recognized characters/words. In one or more embodiments, the searchable ED (107) is a PDF document and the metadata (112) may be stored in the Optional Content Properties Dictionary or Optional Content Configuration Dictionary of the PDF format.

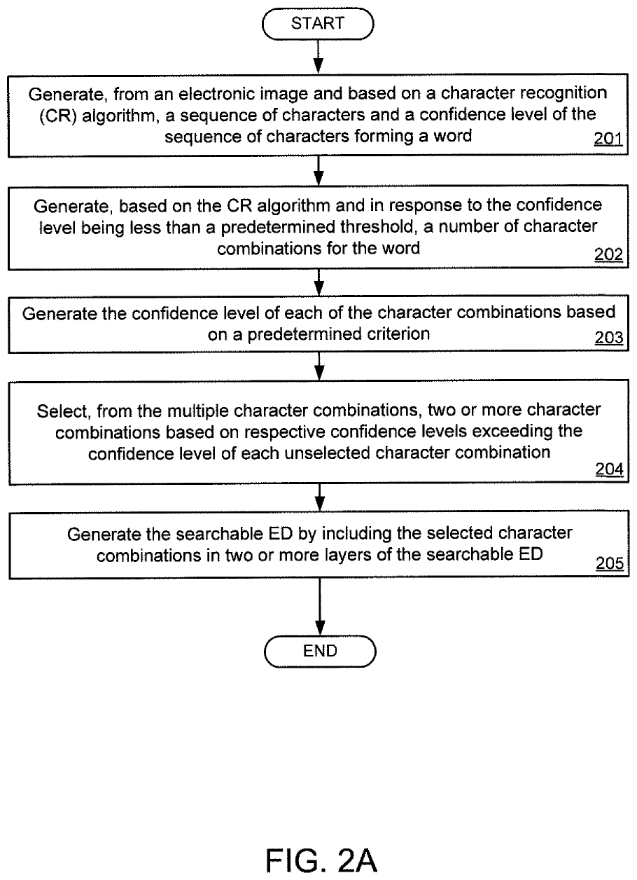

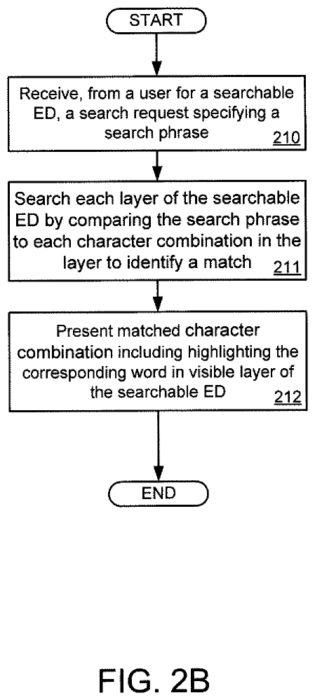

In one or more embodiments of the invention, the analysis engine (110) generates the searchable ED (107) and metadata (112) using the method described in reference to FIG. 2A below.

Although the system (100) is shown as having three components (104, 108, 110), in other embodiments of the invention, the system (100) may have more or fewer components. Further, the functionality of each component described above may be split across components. Further still, each component (104, 108, 110) may be utilized multiple times to carry out an iterative operation.

FIG. 2A shows a flowchart in accordance with one or more embodiments of the invention. The flowchart depicts a process for generating a searchable electronic document (ED). One or more of the steps in FIG. 2A may be performed by the components of the system (100), discussed above in reference to FIG. 1. In one or more embodiments of the invention, one or more of the steps shown in FIG. 2A may be omitted, repeated, and/or performed in a different order than the order shown in FIG. 2A. Accordingly, the scope of the invention should not be considered limited to the specific arrangement of steps shown in FIG. 2A.

Initially, in Step 201 according to one or more embodiments, from an electronic image, a sequence of characters and a confidence level of the sequence of characters forming a word are generated based on a character recognition (CR) algorithm. In one or more embodiments of the invention, the sequence of characters is generated as a recognized word extracted and converted from a text image in the electronic image. In one or more embodiments of the invention, the sequence of characters, or the recognized word, is among a collection of recognized words that are extracted and converted from the electronic image using the CR algorithm. In one or more embodiments, a confidence level of the CR result is generated from intermediate results of the CR algorithm, such as computed correlation between the text image and predetermined character/word templates. For example, the confidence level may pertain to a particular character, a recognized word, an extracted paragraph, or the entire electronic image.

In Step 202 according to one or more embodiments, based on the CR algorithm and in response to the confidence level being less than a predetermined threshold, a number of character combinations for the word are generated. Specifically, the CR algorithm is applied to the text image corresponding to the recognized word to generate individual recognized characters. As described above, when CR ambiguity occurs for multiple characters in the recognized word, multiple character combinations exist for the single recognized word based on logical combinations of different CR results for each individual recognized character.

In Step 203 according to one or more embodiments, the confidence level of each of the character combinations is generated based on a predetermined criterion. In one or more embodiments of the invention, the confidence levels of individual recognized characters in a character combination are combined or otherwise aggregated to generate the confidence level of the character combination. For example, the confidence level of the character combination may correspond to a normalized multiplication product, a normalized sum, a weighted sum, or other mathematically formulated result of the confidence levels of individual recognized characters.

In Step 204 according to one or more embodiments, from the multiple character combinations, two or more character combinations are selected based on respective confidence levels exceeding the confidence level of each unselected character combination. In one or more embodiments, character combinations are sorted according to respective confidence levels. Accordingly, two or more of character combination at top of the list having highest confidence levels ae selected.

In Step 205 according to one or more embodiments, the searchable ED is generated by including the selected character combinations in two or more layers of the searchable ED. In one or more embodiments of the invention, metadata of the searchable ED is generated that identifies the two or more layers and identifies an association of the character combinations with a location of corresponding word in the electronic image. For example, each character combination may be included in an invisible layer of the searchable ED with the metadata identifying the particular invisible layer and where the corresponding word is located in the visible layer of the searchable ED.

FIG. 2B shows a flowchart a flowchart in accordance with one or more embodiments of the invention. The flowchart depicts a process for searching a searchable ED by matching a search phrase to character combinations in multiple layers of the searchable ED. In one or more embodiments of the invention, one or more of the steps shown in FIG. 2B may be omitted, repeated, and/or performed in a different order than the order shown in FIG. 2B. Accordingly, the scope of the invention should not be considered limited to the specific arrangement of steps shown in FIG. 2B.

In Step 210, a search request specifying a search phrase is received from a user. In one or more embodiments of the invention, the user may open the search ED in a file viewer. The user may open a search dialog box in the file viewer and type in the search phrase to search for one or more matched phrases that may lead to relevant information in the searchable ED for the user. The searchable ED is generated using the method described in reference to FIG. 2A above.

In Step 211, each layer of the searchable ED is searched by comparing the search phrase to each character combination in the layer to identify a match. The character combinations and the layers are generated using the method described in reference to FIG. 2A above. In one or more embodiments of the invention, the character combinations and the layers are generated and added to the searchable ED prior to receiving the search request. In one or more embodiments of the invention, the character combinations and the layers are generated and added to the searchable ED in response to receiving the search request. When a match is found, the file viewer obtains the matched character combination and the location of the corresponding text image in the visible layer.

In Step 212, the matched character combination is presented to the user in one or more embodiments of the invention. Presenting the matched character combination may include highlighting the corresponding text image in the visible layer.

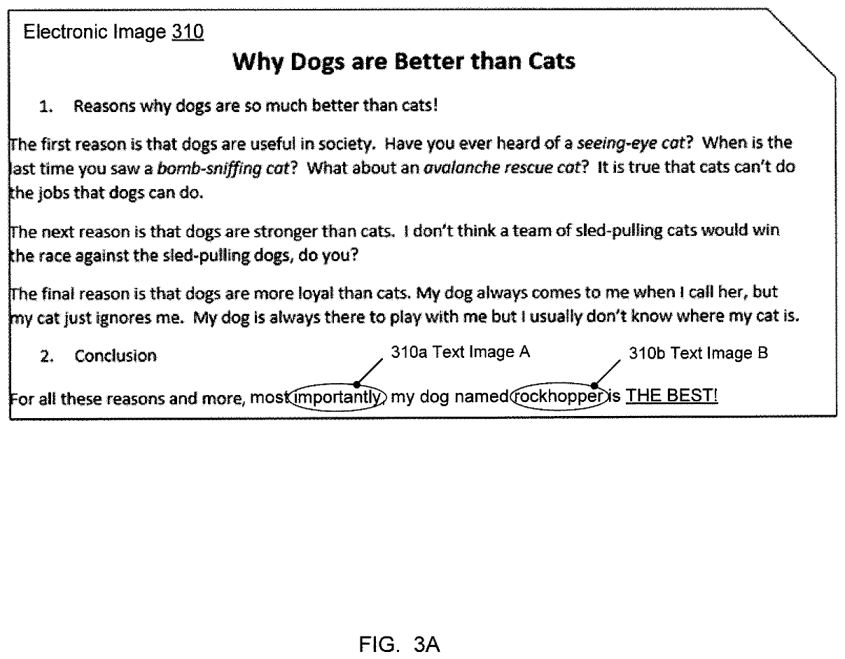

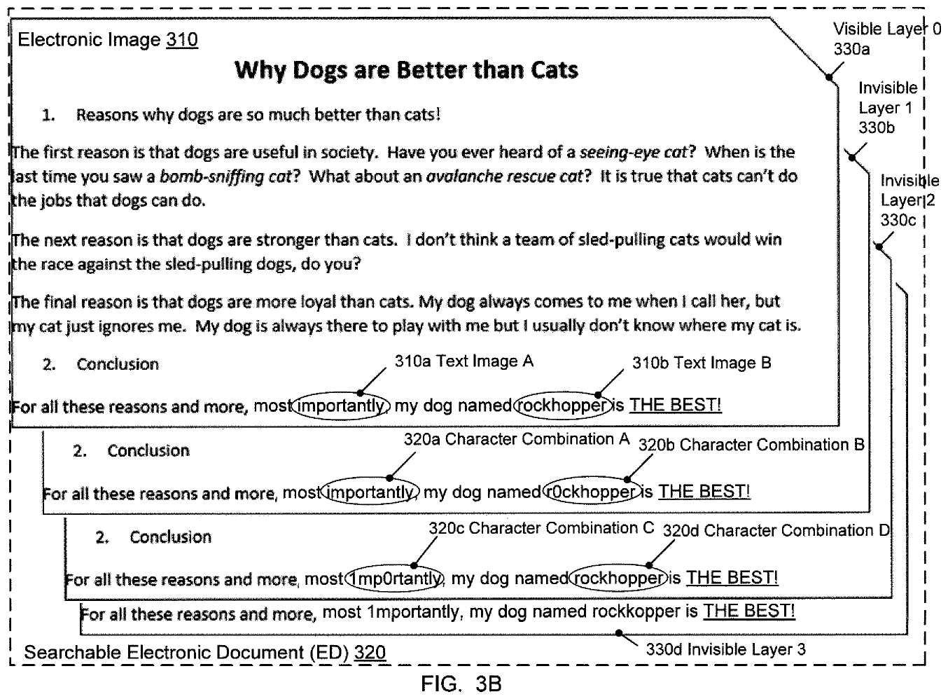

FIGS. 3A-3B show an implementation example in accordance with one or more embodiments of the invention. The implementation example shown in FIGS. 3A-3B is based on the system and method flowchart described in reference to FIGS. 1, 2A, and 2B above. In one or more embodiments of the invention, one or more of elements shown in FIGS. 3A-3B may be omitted, repeated, and/or organized in a different arrangement. Accordingly, the scope of the invention should not be considered limited to the specific arrangement of elements shown in FIGS. 3A-3B.

FIG. 3A shows an electronic image (310) that is generated by scanning a paper document. For example, the electronic image (310) may be in JPEG format or a non-searchable PDF format. In particular, the electronic image (310) includes a text image A (310a) and text image B (310b) depicting the words “importantly” and “rockhopper,” respectively. Specifically, the words “importantly” and “rockhopper” exist in the electronic image (310) as pixel-based bit map images and are not searchable by a text searching tool. Using a character recognition tool, such as OCR or ICR tool, the electronic image (310) is converted into a searchable ED. However, the recognized words in the searchable ED that are generated from the text image A (310a) and text image B (310b) may contain CR errors due to quality of the scanning or crumpling of the paper document. As a result of the CR errors, the text searching tool may not return any matched phrase. For example, if the initially recognized word for the text image A (310a) is “important,” then the text searching tool will fail to return any search result using a search phrase containing “important.” Similarly, if the initially recognized word for the text image B (310b) is “r0ckhopper,” then the text searching tool will fail to return any search result using a search phrase containing “rockhopper.” The search failure associated with the text image A (310a) may be alleviated by using a dictionary to infer the correct word “important” from the recognized word “important.” However, the dictionary may not alleviate the search failure associated with the text image B (310b) because the word “rockhopper” may not be included in the dictionary.

Using the method and system described in reference to FIGS. 1, 2A, and 2B above, when the CR algorithm detects a low confidence level, e.g., due to CR ambiguity of the text image A (310a) and/or text image B (310b), the CR algorithm generates individual characters instead of recognized words. For example, the CR algorithm may generate individual characters as a default for low confidence. In another example, the analysis engine depicted in FIG. 1 above may request, when encountering a low confidence recognized word during searchable ED generation, the CR algorithm to generate individual characters. Due to low quality scanning or crumpled printed paper document, the CR algorithm may generate multiple recognized characters corresponding to a single character in the electronic image (310). For example, the recognized characters corresponding to “i” in the text image A (310a) may include lower case “i,” upper case “I,” numeral “1,” and lower case “l,” with respective confidence levels. In another example, the recognized characters corresponding to “o” in the text image A (310a) or text image B (310b) may include lower case “o,” upper case “O,” and numeral “0,” with respective confidence levels. In yet another example, the recognized characters corresponding to “h” in the text image B (310b) may include lower case “h” and lower case “k,” with respective confidence levels. Combining the three examples above with one occurrence of “i,” three occurrences of “o,” and one occurrence of “h” in the text image A (310a) and text image B (310b), 4*3³*2 or 216 character combinations exist for the word pair “importantly” and “rockhopper” in the electronic image (310). The 216 character combinations includes permutations of (i) lower case “i,” upper case “I,” numeral “1,” and lower case “l,” (ii) lower case “o,” upper case “O,” and numeral “0,” and (iii) lower case “h” and lower case “k. For example, the 216 character combinations includes “imp0rtantly,” “importantly,” Importantly,” “Imp0rtantly,” “importantly,” etc. compounded by “r0ckhopper,” “rockh0pper,” “rockhopper,” “r0ckh0pper,” etc. After sorting the 216 character combinations according to respective confidence levels, top 3 high confidence character combinations of the word pair “importantly” and “rockhopper” are selected and included in three invisible layers of the searchable ED shown in FIG. 3B

As shown in FIG. 3B, the searchable ED (320) includes a visible layer 0 (330a) containing the electronic image (310) and multiple invisible layers composed of recognized words and character combinations. In particular, the electronic image (310) in the visible layer (330a) may be in JPEG format or a non-searchable PDF format. In contrast, the invisible layers include searchable machine-encoded text. For example, the invisible layer 1 (330b) includes the character combination A (320a) and character combination B (320b), the invisible layer 2 (330c) includes the character combination C (320c) and character combination D (320d), and the invisible layer 3 (330d) with additional unlabeled character combinations. Note that the recognized characters “i,” “o,” and “h” may not be assigned the highest confidence level due to scan quality or crumpling of paper document. In other words, the author intended character “i” in the text image A (310a) may actually appear more like numeral “1” resulting in the character combination C (320c) having a high confidence level. Similarly, the author intended character “o” in the text image A (310a) and text image B (310b) may actually appear more like numeral “0” resulting in both the character combination C (320c) and character combination B (320b) having high confidence levels. As a result, the recognized characters “1” and “0” contribute to the character combination A (320a), character combination B (320b), character combination C (320c), and character combination D (320d) become top high confidence selections from the 216 character combinations. While not being assigned the highest confidence levels, the recognized word “importantly” is included in the invisible layer 1 (330b), and the recognized word “rockhopper” is included in the invisible layer 2 (330c). When the text searching tool compares the search phrase containing “importantly” or “rockhopper” to character combinations in the 3 invisible layers of the searchable ED (320), either word is matched such that the text image A (310a) or text message B (310b) is highlighted based on the metadata associating the matched character combination A (320a) and character combination D (320d) to locations of the text image A (310a) and text image B (310b) in the visible layer 0 (330a).

Although the example described above is based on low confidence levels of recognized words from two text messages, the invention equally applies to other examples with low confidence recognized word(s) from more or less text messages. For example, the invisible layers 0-3 may be generated in response to detecting low confidence level of the recognized word from the text message A (310a) alone. In such example, each of three different character combinations having high confidence for “importantly” is inserted in one of the invisible layers 0-3. In contrast, each of the remaining recognized words unrelated to the text image A (310a) does not vary among the three invisible layers 0-3. In particular for this example, the text image B (310b) is converted into the same recognized word for all invisible layers 0-3.

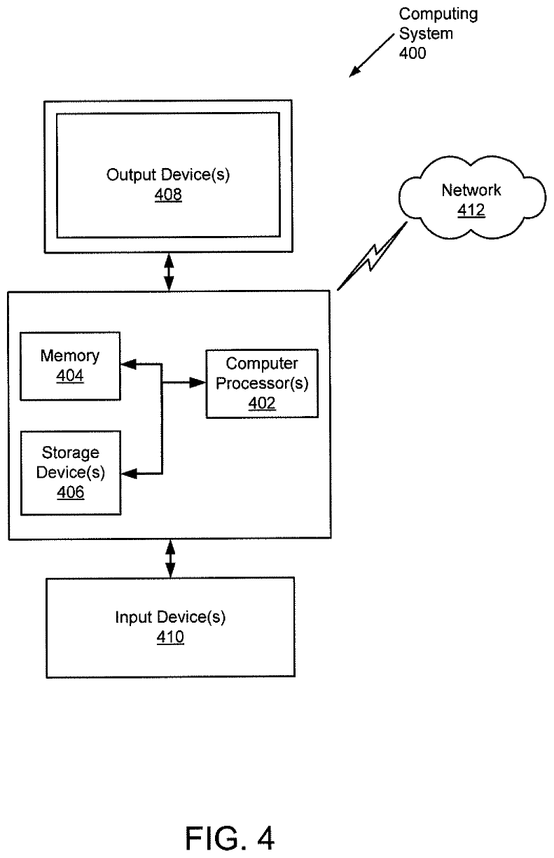

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and be connected to the other elements over a network (412). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for a computer processor to generate a searchable electronic document (ED), comprising:
generating, from an electronic image and based on a character recognition (CR) algorithm, a plurality of characters and a confidence level of the plurality of characters forming a word;
generating, based on the CR algorithm and in response to the confidence level being less than a predetermined threshold, a plurality of character combinations for the word;
generating, based on a predetermined criterion, a confidence level of each of the plurality of character combinations; and
generating the searchable ED by including, based on the confidence level of each of the plurality of character combinations, two or more character combinations of the plurality of character combinations in two or more layers of the searchable ED.

2. The method of claim 1, further comprising:
generating, based on the predetermined criterion, a confidence level of each character of the plurality of character combinations; and
aggregating, for each of the plurality of character combinations, the confidence level of each character in the character combination to generate the confidence level of that character combination.

3. The method of claim 2, further comprising:
selecting, from the plurality of character combinations, the two or more character combinations based on respective confidence levels of the two or more character combinations exceeding the confidence level of each unselected character combinations.

4. The method of claim 1,
wherein the searchable ED is a Portable Document Format (PDF) document, and
wherein the electronic image and the two or more layers are layers of the PDF document.

5. The method of claim 1, further comprising:
generating metadata of the searchable ED,
wherein the metadata identifies the two or more layers and identifies an association of the two or more character combinations with a location of the word in the electronic image.

6. The method of claim 5, further comprising:
receiving, from a user, a search phrase comprising the word;
determining, by comparing the search phrase to contents of the two or more layers, a match between the word and one of the two or more character combinations; and
generating a search result based on the match.

7. The method of claim 6, further comprising:
presenting the search result by highlighting, based on the metadata of the searchable ED, the location of the word in the image.

8. A non-transitory computer readable medium (CRM) storing computer readable program code for generating a searchable electronic document (ED), wherein the computer readable program code, when executed by a computer processor, comprises functionality for:
generating, from an electronic image and based on a character recognition (CR) algorithm, a plurality of characters and a confidence level of the plurality of characters forming a word;
generating, on the CR algorithm and in response to the confidence level being less than a predetermined threshold, a plurality of character combinations for the word;
generating, based on a predetermined criterion, a confidence level of each of the plurality of character combinations; and
generating the searchable ED by including, based on the confidence level of each of the plurality of character combinations, two or more character combinations of the plurality of character combinations in two or more layers of the searchable ED.

9. The CRM of claim 8, the computer readable program code, when executed by the computer processor, further comprising functionality for:
generating, based on the predetermined criterion, a confidence level of each character of the plurality of character combinations; and
aggregating, for each of the plurality of character combinations, the confidence level of each character in the character combination to generate the confidence level of that character combination.

10. The CRM of claim 9, the computer readable program code, when executed by the computer processor, further comprising functionality for:
selecting, from the plurality of character combinations, the two or more character combinations based on respective confidence levels of the two or more character combinations exceeding the confidence level of each unselected character combinations.

11. The CRM of claim 8,
wherein the searchable ED is a Portable Document Format (PDF) document, and
wherein the electronic image and the two or more layers are layers of the PDF document.

12. The CRM of claim 8, the computer readable program code, when executed by the computer processor, further comprising functionality for:
generating metadata of the searchable ED,
wherein the metadata identifies the two or more layers and identifies an association of the two or more character combinations with a location of the word in the electronic image.

13. The CRM of claim 12, the computer readable program code, when executed by the computer processor, further comprising functionality for:
receiving, from a user, a search phrase comprising the word;
determining, by comparing the search phrase to contents of the two or more layers, a match between the word and one of the two or more character combinations; and
generating a search result based on the match.

14. The CRM of claim 13, the computer readable program code, when executed by the computer processor, further comprising functionality for:
presenting the search result by highlighting, based on the metadata of the searchable ED, the location of the word in the image.

15. A system for generating a searchable electronic document (ED), the system comprising:
a memory; and
a computer processor connected to the memory and that:
generates, from an electronic image and based on a character recognition (CR) algorithm, a plurality of characters and a confidence level of the plurality of characters forming a word;
generates, on the CR algorithm and in response to the confidence level being less than a predetermined threshold, a plurality of character combinations for the word;
generates, based on a predetermined criterion, a confidence level of each of the plurality of character combinations; and
generates the searchable ED by including, based on the confidence level of each of the plurality of character combinations, two or more character combinations of the plurality of character combinations in two or more layers of the searchable ED.

16. The System of claim 15, the computer processor further:
generates, based on the predetermined criterion, a confidence level of each character of the plurality of character combinations; and
aggregates, for each of the plurality of character combinations, the confidence level of each character in the character combination to generate the confidence level of that character combination.

17. The System of claim 16, the computer processor further configured to:
select, from the plurality of character combinations, the two or more character combinations based on respective confidence levels of the two or more character combinations exceeding the confidence level of each unselected character combinations.

18. The System of claim 15,
wherein the searchable ED is a Portable Document Format (PDF) document, and
wherein the electronic image and the two or more layers are layers of the PDF document.

19. The System of claim 15, the computer processor further configured to:
generate metadata of the searchable ED,
wherein the metadata identifies the two or more layers and identifies an association of the two or more character combinations with a location of the word in the electronic image.

20. The System of claim 19, the computer processor further configured to:
receive, from a user, a search phrase comprising the word;
determine, by comparing the search phrase to contents of the two or more layers, a match between the word and one of the two or more character combinations; and
generate a search result based on the match.

21. The System of claim 20, the computer processor further configured to:
present the search result by highlighting, based on the metadata of the searchable ED, the location of the word in the image.
